(19) United States
(12) Patent Application Publication
(10) Pub. No.: US 2005/0156901 A1
(43) Pub. Date: Jul. 21, 2005

(54) Touch screen display system

(76) Inventors: Guolin Ma, Milpitas, CA (US); Jason T. Hartlove, Los Altos, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/760,728

(22) Filed: Jan. 20, 2004

(51) Int. Cl. G09G 5/00

(52) U.S. Cl. 345/173

(57) ABSTRACT

A touch screen display system includes a display screen positioned in a first plane. A touch surface is positioned in a second plane adjacent to the display screen. An illuminating source is configured to illuminate the display screen and the touch surface. A first imaging sensor is positioned in the second plane and configured to detect an object coming in contact with the touch surface. A second imaging sensor is positioned in the second plane and configured to detect an object coming in contact with the touch surface. An imaging system is electrically coupled to the first and second imaging sensors and configured to receive electrical signals from the first and second imaging sensors relating to the detection of the object coming in contact with the touch surface. The imaging system configured to determine an angular position on the touch surface of the object coming in contact with the touch surface based upon the received electrical signals.

### BACKGROUND

The present invention relates generally to a user interface system, and more particularly to a display system capable of identifying a location of an interaction of an object with a touch pad.

Touch pad displays or touch screens for data entry are known in the art. A touch pad allows a user to enter data or a menu selection by interacting with a display screen via an implement or object, such as a finger or a stylus, at a location on the display screen that corresponds to a menu item, function, or data alphanumeric character to be entered. There are various prior art technologies used to determine the location of the object or implementation coming in contact with a touch pad display. Once the coordinates of the touch event are determined, the meaning of the touch event can be pressured by a central processing unit (CPU) via the coordinate location and the corresponding menu or data option displayed at that location.

There are several prior art touch display system sensitive to an operator positioning an implement or an object such as a stylus or a finger on a display screen. One example of a prior art touch pad display includes pressure sense technology which utilizes pressure sensors surrounding a glass panel suspended in front of the display to identify a touch event. This technology is expensive and is hindered by mechanical interference in that too great or too little applied pressure may not be properly recognized or may damage the display.

Other examples of prior art touch pad display systems includes capacitive and/or resistive technologies to identify a touch event. In capacitive technologies, the grounding effect on AC voltages injected into the touch panel is measured. A change in capacity at a particular point indicates a touch event. In resistive technologies, either a voltage source is connected across a resistive touch screen or a current is forced through the resistive touch screen. A change in resistance between two adjacent layers caused by pressure from an object or implement is measured. However, capacitive and resistive technologies suffer in that varying amounts of pressures are applied by either a finger of a user or another implement, such as a stylus. These varying pressures often cause false positive readings, meaning the indication of a touch event in absence of user interaction, or false negative readings, meaning lack of an indication of a touch event when user interaction has occurred within the touch panel display systems.

### SUMMARY

One aspect of the present invention provides a touch screen display system including a display screen positioned in a first plane. A touch surface is positioned in a second plane adjacent to the display screen. An illuminating source is configured to illuminate the display screen and the touch surface. A first imaging sensor is positioned in the second plane and configured to detect an object coming in contact with the touch surface. A second imaging sensor is positioned in the second plane and configured to detect an object coming in contact with the touch surface. An imaging system is electrically coupled to the first and second imaging sensors and configured to receive electrical signals from the first and second imaging sensors relating to the detection of the object coming in contact with the touch surface. The imaging system is configured to determine an angular position on the touch surface of the object coming in contact with the touch surface based upon the received electrical signals.

### BRIEF DESCRIPTION OF THE DRAWINGS

FIG. 1 is a two-dimensional front view illustrating a touch pad and a display screen in accordance with one embodiment of the present invention.

FIG. 2 is a block diagram illustrating an imaging sensor in accordance with one embodiment of the present invention.

FIG. 3 is a two-dimensional front view illustrating a touch pad and a display screen incorporating an alternate embodiment of the present invention.

FIG. 4 is a block diagram illustrating a user interface system in accordance with one embodiment of the present invention.

FIGS. 5A and 5B are three-dimensional views illustrating a display screen and a touch pad in accordance with one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

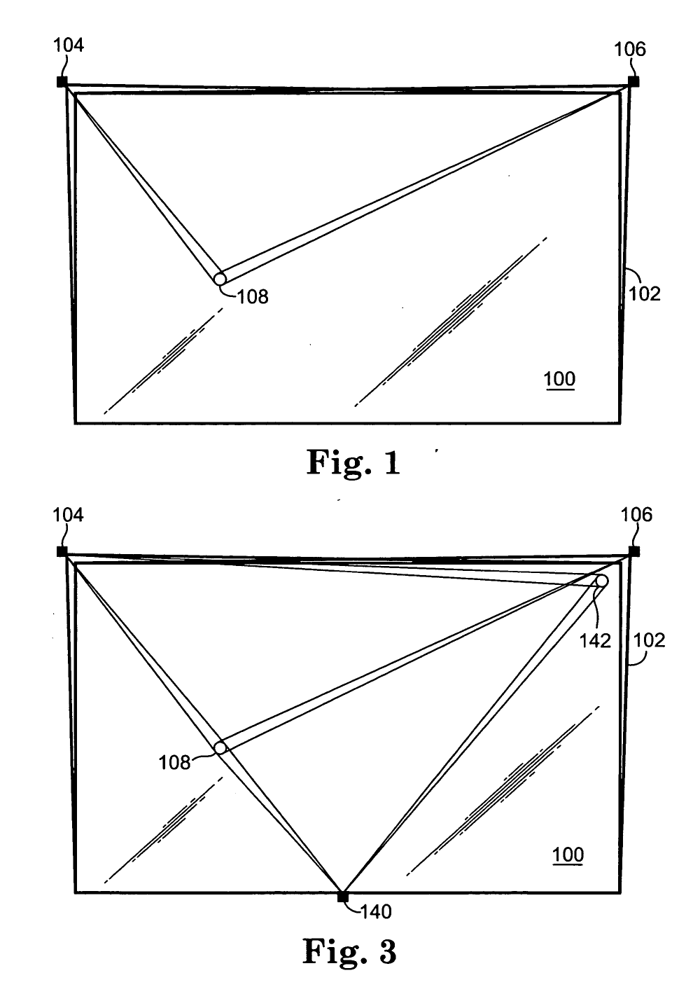

FIG. 1 is a two-dimensional front view illustrating one embodiment of touch pad 100 and display screen 102. As shown in FIG. 1, display screen 102 is positioned in a first plane and touch pad 100 is positioned in a second plane in front of and immediately adjacent to display screen 102. Other terminology for touch pad 100 includes touch surface 100 and touch panel display 100, while display screen 102 may also be called display 100. Also shown in FIG. 1 are imaging sensors 104 and 106. Imaging sensors 104 and 106 are positioned in the second plane and are configured to detect an object or implement, such as a finger, a pen, or a stylus, coming in contact with touch pad 100. Touch pad 100 and display screen 102 provide a source of interaction between a user and the user interface system of the present invention. Touch pad 100 allows a user to make a selection by interacting with display screen 102 via touch pad 100 at a location on the display screen corresponding to a menu item, function, or data alphanumeric character to be entered.

In one embodiment, display screen 102 is a flat panel display screen, and touch pad 100 is a flat panel touch pad. In this embodiment, touch pad 100 and display screen 102 would not have any curve surfaces associated with them to ensure that imaging sensors 104 and 106 are capable of sensing an object or implement coming in contact with any portion of the surface area of touch pad 100, since it is known that imaging sensors may detect objects within a straight line of sight, rather than around curved surfaces.

In one embodiment, touch pad 100 and display screen 102 represent a touch surface and a display associated with a computer, either desktop, laptop, or notebook. However, in other embodiments, touch pad 100 and display screen 102 represent a touch pad display and display screen associated with any number of electrical and/or computer equipment, including, but not limited to, an automatic teller machine, a check-out machine at a merchant store, an order input device at a restaurant, gas station, or other merchant business, a vehicle control system within an automobile, an input display associated with a telephone, wireless phone, or pager, or an input device associated with a camera.

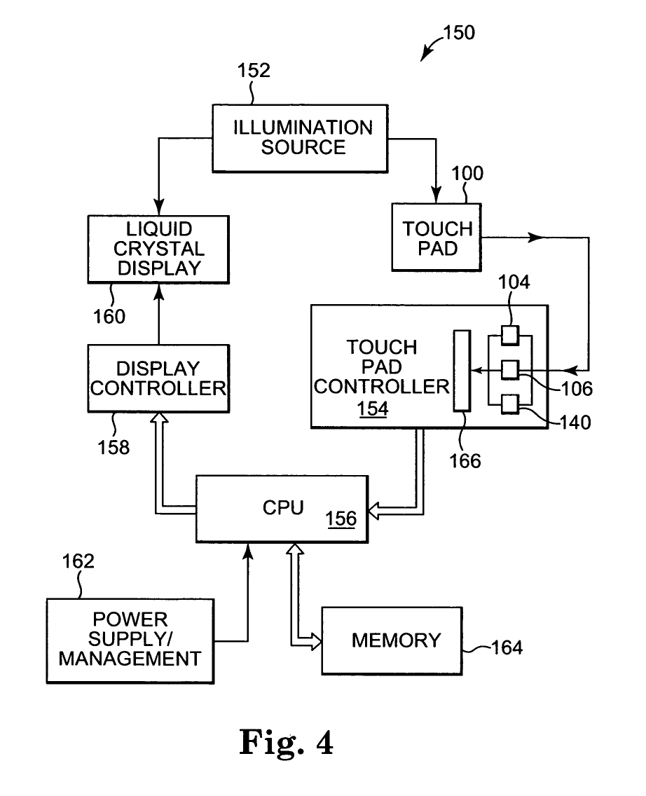

Imaging sensors 104 and 106 are illustrated in FIG. 1 immediately adjacent the two corners of touch pad 100. However, it is understood that imaging sensors 104 and 106 may be positioned at any location about touch pad 100. In one embodiment, imaging sensors 104 and 106 are positioned about touch pad 100 having the greatest possible distance between them. In accordance with the present invention, it is desirous for imaging sensors to be spacially located from each other to ensure proper independent detection and sensing. Imaging sensors 104 and 106 are continuously sensing the surface area of touch pad 100 and are capable of detecting an object or implement coming in contact with touch pad 100. For example, as shown in FIG. 1, point 108 represents a touch event of an object or implement, such as a finger, a pen, a stylus, or another object(s), coming in contact with touch pad 100. As shown in FIG. 1, imaging sensors 104 and 106 independently, independent of each other, detect an object or implement coming in contact with touch pad 100 at point 108. Information relating to the touch event is sent from imaging sensors 104 and 106 to an imaging system, discussed with reference to FIG. 4. It is desirous for at least two imaging sensors to identify a touch event. Each imaging sensor is capable of locating a touch event in a single dimension. Therefore, at least two imaging sensors are necessary to determine a two-dimensional location (x, y), or angular location, of a touch event.

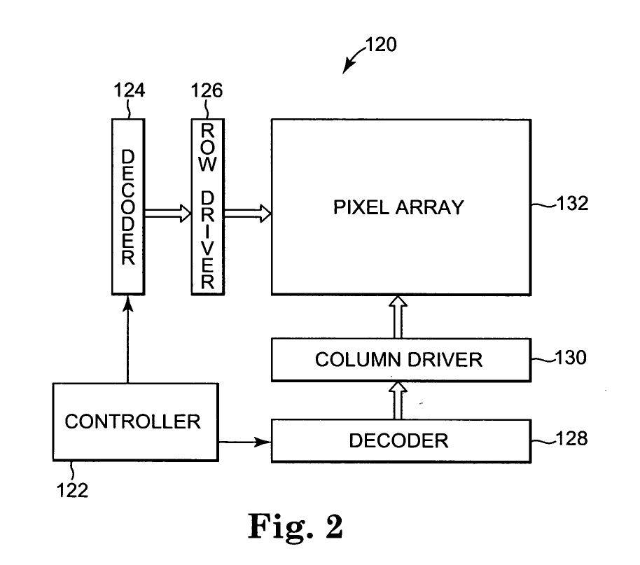

In one embodiment, imaging sensors 104 and 106 are each a complementary metal oxide semiconductor (CMOS) imaging sensor or device. However, in other embodiments, imaging sensors 104 and 106 may each be a photodiode, a photodetector, or a charge coupling device (CCD). FIG. 2 is a block diagram illustrating one embodiment of imaging sensors 104 and 106. In particular, FIG. 2 illustrates one embodiment of CMOS imaging sensor 120. CMOS imaging sensor 120 includes controller 122, row decoder 124, row driver 126, column decoder 128, column driver 130, and pixel array 132. CMOS imaging sensor 120 includes numerous photosites each photosite associated with a pixel (short for picture element). The resolution of CMOS imaging sensor 120 is determined by how many photosites or pixels are placed upon its surface. The resolution may be specified by the total number of pixels in its images. The resolution of CMOS imaging sensor 120 may vary depending on the application without deviating from the present invention. However in one embodiment, CMOS imaging sensor 120 has a resolution of at least 16,000 pixels. In one preferred embodiment, CMOS imaging sensor 120, which represents imaging sensors 104 and 106, has a resolution of 256,000 (256k) pixels.

CMOS imaging sensor 120 offers a number of advantages over CCDs. CMOS imaging sensor 120 consumes much less power than similar CCDs. This advantage is particularly important for consumer electronic products, such as computers. Higher yields and less susceptibility to defects make CMOS technology a lower cost technology for imaging sensors, as compared to CCDs. Fewer parts, a smaller form factor, and higher reliability in the end products are additional advantages over CCDs.

CMOS imaging devices, such as CMOS imaging sensor 120, tend to more specifically recognize images coming in contact with touch pad 100 than CCDs. CCDs rely in a process than can leak charge to adjacent pixels when the CCD register overflows; thus bright lights “bloom” and cause unwanted streaks in the identified images. CMOS imaging devices are inherently less sensitive to this effect. In addition, smear—caused by charged transfer in the CCD or other illumination—is nonexistent with CMOS imaging devices.

Referring to FIG. 2, pixel array 132 comprises a plurality of pixels arranged in a predetermined number of columns and rows. The row lines are selectively activated by row driver 126 in response to row address decoder 124, and the column lines are selectively activated by column driver 130 in response to column address decoder 128. Thus, a row and column address is provided for each pixel. CMOS imaging sensor 120 is operated and controlled by controller 122 which controls row and column address decoders 124 and 128 for determining the appropriate row and column lines associated with the pixel or pixels in which an object or implement are touching an associated location on touch pad 100.

FIG. 3 is a two-dimensional front view illustrating one embodiment of touch pad 100 and display screen 102. As shown in FIG. 3, three imaging sensors 104, 106, and 140 are spacially positioned about touch pad 100 such that no imaging sensor is in close proximity to another imaging sensor. Proper spacial positioning ensures that each imaging sensor independently directs and senses a touch event. As shown in FIG. 3, touch pad 100 and associated circuitry includes point 142, which represents a touch event of an object or implement coming in contact with touch pad 100 at point 142. As shown in FIG. 3, point 142 is located in close proximity to imaging sensor 106. In this example, imaging sensor 106 may not be capable of precisely identifying the location of the touch event of an object or implement coming in contact with touch pad 100. Due to resolution constraints, a touch by a finger, for example, in close proximity to an imaging sensor, such as imaging sensor 106, may inhibit imaging sensor 106 and associate circuitry from identifying the angular position, location, or size of the touch event. Therefore, imaging sensor 106 having a CMOS design and a resolution of 256,000 pixels may not have enough resolution to accurately determine the angular location and size of the touch event. To rectify this situation, a third imaging sensor 140, has been added. A touch in close proximity to a single sensor is positively and accurately identified by the remaining two image sensors. Thus, the two-dimensional angular location of any touch event of touch pad 100 can be determined. In addition, the size of the touch event (such as a finger having a substantially large surface area, as compared to a stylus tip having a substantially small surface area) is determined by the number of pixels sensing the touch event. The size of the touch event may be relevant depending on the application being run associated with display screen 102.

FIG. 4 is a block diagram of user interface system 150 in accordance with one embodiment of the present invention. User interface system 150 includes illumination source 152, touch pad 100, touch pad controller 154, central processing unit (CPU) 156, display controller 158, liquid crystal display (LCD) 160, power supply/management 162, and memory 164. Touch pad 100 may also be called a touch panel display or a touch surface and is identical to touch pad 100 shown in FIG. 1. LCD 160 represents one embodiment of display screen 102 shown in FIG. 1. In one embodiment, LCD 160 is a flat screen or flat panel display and touch pad 100 is a flat panel touch pad.

Illumination source 152 provides the lighting necessary to illuminate LCD 160, which can be seen through touch pad 100. In one embodiment, touch pad 100 is clear or opaque, such that alphanumeric characters and symbols can be seen through touch pad 100. In one embodiment, illumination source 152 is a backlight source, as is known in the computer and electrical component art. Touch pad controller 154 includes imaging sensors 104, 106, and 140, as well as imaging system 166. Imaging sensors 104, 106, and 140 are the same as those shown in FIG. 3 positioned in the same plane as touch pad 100 and distally placed about touch pad 100 such that at least two of the three imaging sensors can precisely detect an object or implement coming in contact with touch pad 100 and determine the exact angular position and size of the object coming in contact with touch pad 100.

Imaging sensors 104, 106, and 140 are electrically coupled to imaging system 166 of touch pad controller 154. Imaging system 166 is configured to receive electrical signals from imaging sensors 104, 106, and 140 relating to the detection of an object or implement coming in contact with touch pad 100. Imaging system 166 is also configured to determine an angular position and size on touch pad 100 of the object or implement coming in contact with touch pad 100 based upon the received electrical signals. Examples of received electrical signals correspond to information from CMOS sensor 120 relating to the specific pixels sensing the touch event (angular location of touch event) and the number of pixels sensing the touch event (size of touch event). CPU 156 receives information from touch pad controller 154 relating to the detection of an object or implement coming in contact with touch pad 100 and the angular location and size of the object or implement coming in contact with touch pad 100. CPU 156 provides information and data relating to the next screen to be displayed by LCD 160 based upon the information or data received from touch pad controller 154 in conjunction with information or data relating to the current display screen on LCD 160. Data or information relating to the next screen to be displayed upon LCD 160 is then transmitted to display controller 158 that provides electrical signals to LCD 160, thereby updating LCD 160 with a new screen based upon previous touch events.

Power supply/management 162 provides the power to user interface system 150, specifically CPU 156. Memory 164 provides a memory component for user interface system 150, which may be necessary or advantageous, based upon the application or system in which user interface system is included.

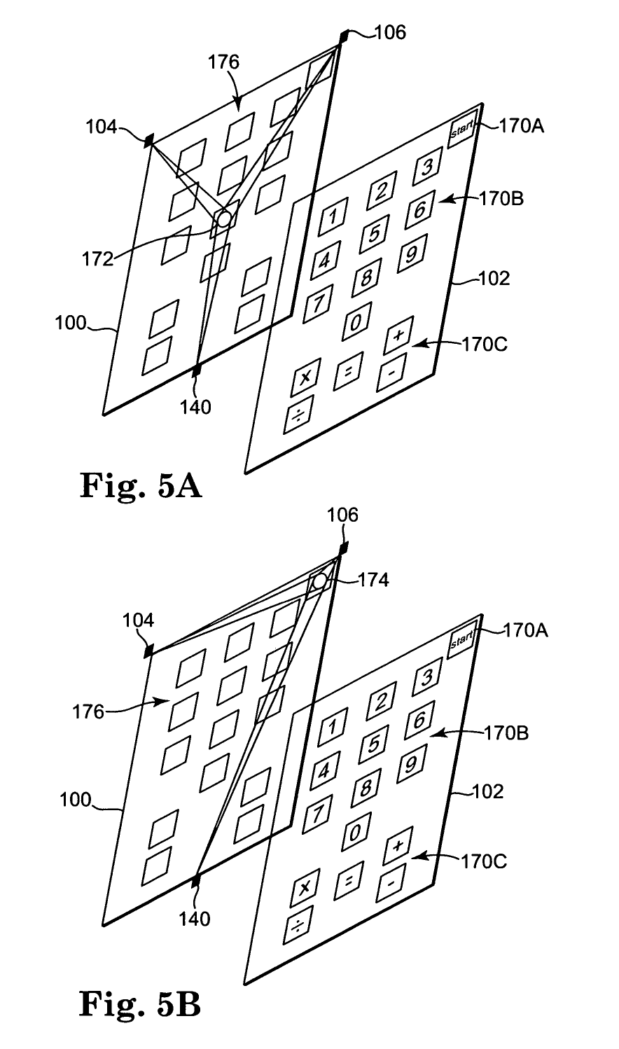

FIG. 5A is a three-dimensional view illustrating one embodiment of touch pad 100 and display screen 102. As shown in FIG. 5A, imaging sensors 104, 106, and 140 are positioned in the same plane as touch pad 100 and distally placed about touch pad 100 such that at least two of the three imaging sensors can precisely detect a touch event. The combination of imaging sensors 104, 106, and 140 and imaging system 166 determine and provide the angular location and size of the touch event. While imaging sensors 104, 106, and 140 are positioned at specific locations in FIG. 5A, it is understood that imaging sensors 104, 106, and 140 may be positioned at any locations about or around touch pad 100, as long as the sensors are distally positioned from each other in the same plane as touch pad 100 such that at least two of the sensors are capable of detecting and positively identifying the angular location and size of an object or implement coming in contact with touch pad 100.

As shown in FIG. 5A, a set of functional components or data entry buttons 170A, 170B, and 170C are displayed on display screen 102. Functional components 170A, 170B, and 170C may comprise, for example, a data entry screen or menu having a pre-arranged set of discretely labeled data entry and/or functional buttons. However, it is understood that any form of static or dynamic set of functional components could be presented on display screen 102 depending on the desired application. As shown in FIG. 5A, functional component 170A represents a start button; functional components 170B represent various pneumatic buttons; and functional components 170C represent various algebraic mathematical symbol. Point 172 represents a touch event where a user interfaces with a display screen 102 via touch pad 100 at numeral 8. Imaging sensors 104, 106, and 140 along with imaging system 166 (shown in FIG. 4), positively detect the touch event and positively determine the angular position and size of the touch event on touch pad 100 as corresponding to numeral 8 of display screen 102.

Depending on the desired application, CPU 156 (shown in FIG. 4) may provide data and electrical signals to display screen 102 such that the current screen remains visible. Alternatively, based upon the current application and coordinates relating to the touch event, CPU 156 may provide a new screen to be displayed upon display screen 102.

FIG. 5B represents the same embodiment of three-dimensional images of touch pad 100 and display screen 102 as shown in FIG. 5A. However, as shown in FIG. 5B, point 174 represents a touch event at a location corresponding to start key 170A. In this example, imaging sensor 106 may not be able to positively identify the angular location and size of the object or implement coming in contact with touch pad 100. As previously discussed, due to resolution restrictions, imaging sensor 106 may be located too close to point 174 associated with start key 170A. However, in the present application, imaging sensors 104 and 140 will positively identify the touch event at point 174 associated with start key 170A. Data and information relating to the angular location and size of the touch event at point 174 is provided to CPU 156 via touch pad controller 154 and imaging system 166. The exact angular location and size of point 174 will be determined via standard CMOS imaging sensor technology as previously discussed with reference to imaging sensor 120.

The present invention can provide a user interface system including a touch screen display system which is capable of detecting an object or implement coming in contact with a touch pad and positively identifying an angular location and size of the object or implement coming in contact with the touch pad. Two or three imaging sensors can be strategically positioned about a touch pad so that at least two of the imaging sensors can positively identify the location of an object or implement coming in contact with a touch pad and the angular location of the touch. Using standard CMOS imaging sensor technology provides various fabrication advantages over other known touch pad identification systems using consumer electronic products, such as computers.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A touch screen display system comprising:
a display screen positioned in a first plane;
a touch surface positioned in a second plane adjacent to the display screen;
an illumination source configured to illuminate the display screen and the touch surface;
a first imaging sensor positioned in the second plane configured to detect an object coming in contact with the touch surface;
a second imaging sensor positioned in the second plane configured to detect the object coming in contact with the touch surface; and
an imaging system electrically coupled to the first and second imaging sensors and configured to receive electrical signals from the first and second imaging sensors relating to the detection the an object coming in contact with the touch surface, the imaging system also configured to detect an angular position on the touch surface of the object coming in contact with the touch surface based upon the received electrical signals.

2. The touch screen display system of claim 1, wherein the first imaging sensor further comprises:
a complementary metal oxide semiconductor sensor.

3. The touch screen display system of claim 1, wherein the second imaging sensor further comprises:
a complementary metal oxide semiconductor sensor.

4. The touch screen display system of claim 1, wherein the first and second imaging sensors each have a resolution of at least 16,000 pixels.

5. The touch screen display system of claim 1, wherein the imaging system is configured to determine the size of the object coming in contact with the touch surface based upon the received electrical signals.

6. The touch screen display system of claim 1, wherein the display screen further comprises a flat panel display screen, and wherein the touch surface further comprises a flat panel touch surface.

7. The touch screen display system of claim 1, and further comprising:
a third imaging sensor positioned in the second plane configured to detect an object coming in contact with the touch surface; and
wherein the imaging system is electrically coupled to the third imaging sensor and configured to receive electrical signals from the third imaging sensor relating to the detection of the object coming in contact with the touch surface, the imaging system further configured to determine the angular position of the object coming in contact with the touch surface based upon the receive electrical signals.

8. The touch screen display system of claim 6, wherein the third imaging sensor further comprises:
a complementary metal oxide semiconductor sensor.

9. A system capable of identifying a location of an interaction of an object with a touch panel display positioned in a first plane, the system comprising:
a first imaging sensor positioned in the first plane configured to detect an object coming in contact with the touch surface;
a second imaging sensor positioned in the first plane configured to detect the object coming in contact with the touch surface; and
an imaging system electrically coupled to the first and second imaging sensors and configured to receive electrical signals from the first and second imaging sensors relating to the detection of the object coming in contact with the touch surface, the imaging system also configured to determine an angular position on the touch surface of the object coming in contact with the touch surface based upon the received electrical signals.

10. The system of claim 9, wherein the first imaging sensor further comprises:
a complementary metal oxide semiconductor.

11. The system of claim 9, wherein the second imaging sensor further comprises:
a complementary metal oxide semiconductor sensor.

12. The system of claim 9, wherein the first and second imaging sensors each have a resolution of at least 16,000 pixels.

13. The system of claim 9, wherein the imaging system is configured to determine the size of the object coming in contact with the touch surface based upon the receive electrical signals.

14. The system of claim 9, wherein the touch panel display further comprises a flat panel touch panel display.

15. The system of claim 9, and further comprising:
a third imaging sensor positioned in the first plane configured to detect an object coming in contact with the touch surface; and
wherein the imaging system is electrically coupled to the third imaging sensor and configured to receive electrical signals from the third imaging sensor relating to the detection of the object coming in contact with the touch surface, the imaging system further configured to determine the angular position of the object coming in contact with the touch surface based upon the received electrical signals.

16. The system of claim 15, wherein the third imaging sensor further comprises:
a complementary metal oxide semiconductor sensor.

17. A user interface system capable of recognizing an interaction with the system via an implement, the system comprising:
a display positioned in a first plane;
a touch pad positioned in a second plane adjacent to the display;
an illuminating source configured to illuminate the display and the touch pad;
a touch pad controller configured to recognize an angular position of an object coming in contact with the touch pad, the touch pad controller further comprising:
a first imaging sensor positioned in the second plane configured to detect an implement coming in contact with the touch pad;
a second imaging sensor positioned in the second plane configured to detect the implement coming in contact with the touch pad; and
an imaging system electrically coupled to the first and second imaging sensors and configured to receive electrical signals from the first and second imaging sensors relating to the detection of the implement coming in contact with the touch pad, the imaging system also configured to determine an angular position on the touch pad of the object coming in contact with the touch pad based upon the received electrical signals;
a display controller electrically coupled to the display and configured to provide electrical signals to the display such that the display displays a screen based upon the provided electrical signals; and
a central processing unit coupled to the touch pad controller and the display controller and configured to receive signals from the touch pad controller relating to the angular position on the touch pad of an implement coming in contact with the touch pad and configured to provide signals to the display controller based upon the received electrical signals.

18. The system of claim 17, wherein the first imaging sensor further comprises:
a complementary metal oxide semiconductor sensor.

19. The system of claim 17, wherein the second imaging sensor further comprises:
a complementary metal oxide semiconductor sensor.

20. The system of claim 17, wherein the display further comprises a flat panel display, and wherein the touch pad further comprises a flat panel touch pad.

21. The system of claim 17, and further comprising:
a third imaging sensor positioned in the second plane configured to detect an object coming in contact with a touch pad; and
wherein the imaging system is electrically coupled to the third imaging sensor and configured to receive electrical signals from the third imaging sensor relating to the detection of the implement coming in contact with the touch pad, the imaging system configured to determine the angular position of the implement coming in contact with the touch pad based upon the received electrical signals.

22. The system of claim 21, wherein a third imaging sensor further comprises:
a complementary metal oxide semiconductor sensor.
